(19) United States
(12) Patent Application Publication
(10) Pub. No.: US 2013/0205202 A1
(43) Pub. Date: Aug. 8, 2013

(54) Transformation of a Document into Interactive Media Content

(71) Applicants: Jun Xiao, Austin, TX (US); Jiajian Chen, Atlanta, GA (US); Jian Fan, San Jose, CA (US); Eamonn O'Brien-Strain, San Francisco, CA (US)

(72) Inventors: Jun Xiao, Austin, TX (US); Jiajian Chen, Atlanta, GA (US); Jian Fan, San Jose, CA (US); Eamonn O'Brien-Strain, San Francisco, CA (US)

(21) Appl. No.: 13/817,643

(22) PCT Filed: Jul. 31, 2011
(86) PCT No.: PCT/US11/46063

§ 371 Date: Feb. 19, 2013

Related U.S. Application Data
(60) Provisional application No. 61/513,624, filed on Jul. 31, 2011.
(60) Provisional application No. 61/406,780, filed on Oct. 26, 2010.

(51) Int. Cl. G06F 17/22

(52) U.S. Cl. CPC G06F 17/2264
USPC 715/249

(57) ABSTRACT

Systems and methods are provided for transforming a document into interactive media content. A system can include a memory for storing computer executable instructions and a processing unit for accessing the memory and executing the computer executable instructions. The computer executable instructions can include an engine to generate a dynamic composition of the text blocks and visual blocks of the document, based on semantic features of the text blocks and the visual blocks, to provide the interactive media content.

### CROSS-REFERENCE TO RELATED APPLICATIONS

This application claims benefit of U.S. Provisional Application No. 61/406,780, filed Oct. 26, 2010, and U.S. Provisional Application No. 61/513,624, filed Jul. 31, 2011, the disclosures of which are incorporated by reference in their entireties for the disclosed subject matter as though fully set forth herein.

### BACKGROUND

The user's experience of publications has been primarily based on the print medium. Many printed publications are designed and edited professionally. The trend now is to move content to digital format and publish it online. Traditional publishers are increasingly offering publications digitally with use of a portable document format (PDF), a standard for document exchange. An example is Adobe® Acrobat, available from Adobe Systems Inc., San Jose, Calif. With the introduction of a variety of media viewing devices, including portable reading devices, each having varying display sizes and input mechanisms, the ability to deliver content in a format that is well adaptable to the different form factors of the various devices is lacking.

### DESCRIPTION OF DRAWINGS

FIG. 1A is a block diagram of an example of a document transformation system.

FIG. 1B is a block diagram of an example of a computer that incorporates an example of the document transformation system of FIG. 1A.

FIG. 2A is a block diagram of an illustrative functionality implemented by an example computerized document transformation system.

FIG. 2B is a block diagram of another illustrative functionality implemented by an example computerized document transformation system.

FIGS. 3A-3C illustrate an example operation of document transformation system on a document.

FIG. 4 shows an example result of segmentation of a document.

FIGS. 5A-5B illustrate an example display from an implementation of the document transformation system.

FIGS. 6A-6D illustrate another example display from the implementation of the document transformation system.

FIGS. 7A-7B illustrate another example display from the implementation of the document transformation system.

FIGS. 8A-8B illustrate another example display from the implementation of the document transformation system.

FIGS. 9A-9B illustrate another example display from the implementation of the document transformation system.

FIGS. 10A-10B illustrate another example display from the implementation of the document transformation system.

FIG. 11 illustrates another example display from the implementation of the document transformation system.

FIG. 12 is a flow diagram of an example process for transforming a document into interactive media content.

FIG. 13 is a flow diagram of an example process for transforming a document into interactive media content.

FIG. 14 is a flow diagram of an example process for extracting text content from a document.

FIG. 15 is a flow diagram of an example process for transforming a document into interactive media content.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

An “image” broadly refers to any type of visually perceptible content that may be rendered on a physical medium (e.g., a display monitor, a screen, or a print medium). For example, an image can be viewed using a display of a media viewing device. Images may be complete or partial versions of any type of digital or electronic image, including: an image that was captured by an image sensor (e.g., a video camera, a still image camera, or an optical scanner) or a processed (e.g., filtered, reformatted, enhanced or otherwise modified) version of such an image; a computer-generated bitmap or vector graphic image; a textual image (e.g., a bitmap image containing text); and an iconographic image.

The term “image forming element” refers to an addressable region of an image. In some examples, the image forming elements correspond to pixels, which are the smallest addressable units of an image. Each image forming element has at least one respective “image value” that is represented by one or more bits. For example, an image forming element in the RGB color space includes a respective image value for each of the colors (such as but not limited to red, green, and blue), where each of the image values may be represented by one or more bits.

A “computer” is any machine, device, or apparatus that processes data according to computer-readable instructions that are stored on a computer-readable medium either temporarily or permanently. Computer or computer system herein includes media viewing devices (such as but not limited to portable viewing devices). A “software application” (also referred to as software, an application, computer software, a computer application, a program, and a computer program) is a set of machine readable instructions that an apparatus, e.g., a computer, can interpret and execute to perform one or more specific tasks. A “data file” is a block of information that durably stores data for use by a software application.

The term “computer-readable medium” refers to any medium capable of storing information that is readable by a machine (e.g., a computer). Storage devices suitable for tangibly embodying these instructions and data include, but are not limited to, all forms of non-volatile computer-readable memory, including, for example, semiconductor memory devices, such as EPROM, EEPROM, and Flash memory devices, magnetic disks such as internal hard disks and removable hard disks, magneto-optical disks, DVD-ROM/RAM, and CD-ROM/RAM.

The term “web page” refers to a document that can be retrieved from a server over a network connection and viewed in a web browser application.

As used herein, the term “includes” means includes but not limited to, the term “including” means including but not limited to. The term “based on” means based at least in part on.

Mobile services and digital publishing may transform the way media content is consumed. A growing range of media viewing devices, including e-readers and tablets, are available for users to read digital magazines, newspaper and books. Many of these media viewing devices are handheld, lightweight, and have superior displays compared to traditional computer monitors. The interaction design for these media viewing devices is an active area. A novel system and method that can enhance the reading experience could be beneficial.

A system and method herein provide a range of features and capabilities to digital publishing, including books, that facilitate automatically converting static PDF magazines to interactive multimedia applications running on media viewing devices.

Provided herein are systems and methods for transforming static document content into interactive media content and migrating the interactive media content to media viewing devices. The transformation can be performed automatically by a system according to a method described herein. A system and method are provided that utilize document and image analysis to extract individual elements (including text elements and visual elements) from a document, and reconstruct the content by adding semantic transitions, visualizations and interactions, to provide interactive media content.

Non-limiting examples of media viewing device include portable document viewing devices, such as but not limited to smartphones and other hand-held devices, including tablet and slate devices, touch-based devices, laptops, and other portable computer-based devices. In an example, the media viewing device may be part of a booth, a kiosk, a pedestal or other type of support. The media viewing area of the media viewing devices may have different form factors.

Non-limiting examples of a document include portions of a web page, a brochure, a pamphlet, a magazine, and an illustrated book. In an example, the document is in static format. Some document publisher standards address only the issue of reflowing text. Recent document publishers developed to be run on portable document viewing devices use a significant amount of work by graphics and interaction designers to manually reformat the content and wire the user interactions.

A system and method are provided for transforming static documents, including digital publications such as magazines in PDF format, into interactive media content. The interactive media content can be delivered to the portable devices.

A system and method provided herein transforms digital publications into interactive media content having rich dynamic layout and provide a user with the simplicity to navigate the contents. In an example, a method and system can be used to analyze and convert the digital publications into interactive media content automatically.

in an example implementation of a system and method disclosed herein, the system includes a PDF document de-composition and segmentation module, a semantic and feature analysis module, and a presentation and interaction platform.

In an example, an engine is provided to generate a dynamic composition of extracted text blocks and visual blocks of a document, based on semantic features of the visual blocks and attribute data and document functions of the text blocks, to provide the interactive media content.

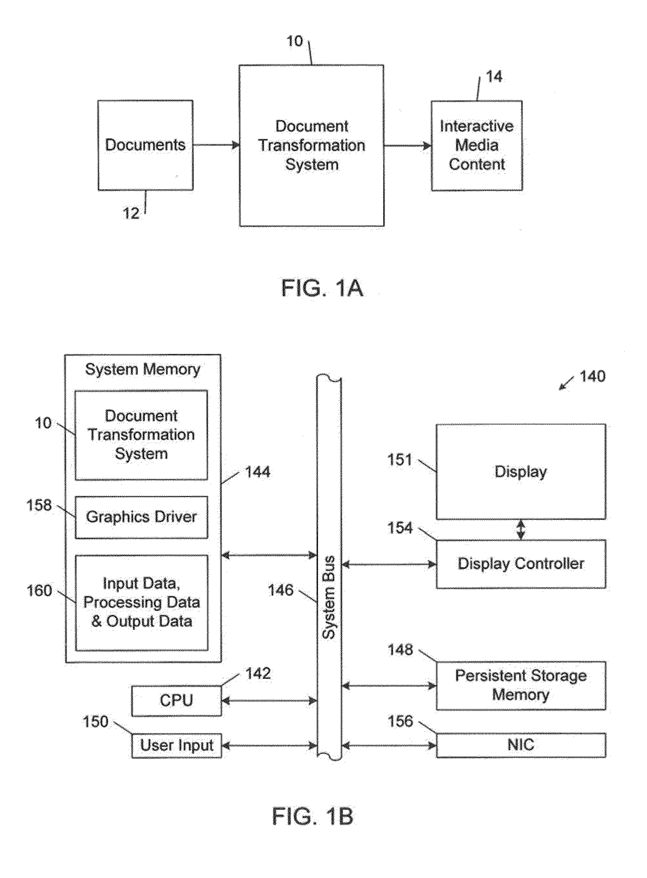

FIG. 1A shows an example of a document transformation system 10 that performs document transformation on documents 12 and outputs interactive media content 14. In an example implementation of the document transformation system 10, a document is de-composed and segmented, semantic and feature analysis is performed, and the interactive media content, generated based on these results; is displayed using a presentation and interaction platform. Document transformation system 10 can provide a fully automated process for document transformation.

Examples of documents 12 include any material in static format, including portions of a web page, a brochure, a pamphlet, a magazine, and an illustrated book.

In some examples, the document transformation system 10 outputs the results from operation of document transformation system 10 by storing them in a data storage device (including, in a database, such as but not limited to a server) or rendering them on a display (including, in a user interface generated by a software application). Non-limiting example displays include the display screen of media viewing devices, such as smartphones, touch-based devices, slates, tablets, e-readers, and other portable document viewing devices.

FIG. 1B shows an example of a computer system 140 that can implement any of the examples of the document transformation system 10 that are described herein. The computer system 140 includes a processing unit 142 (CPU), a system memory 144, and a system bus 146 that couples processing unit 142 to the various components of the computer system 140. The processing unit 142 typically includes one or more processors, each of which may be in the form of any one of various commercially available processors. The system memory 144 typically includes a read only memory (ROM) that stores a basic input/output system (BIOS) that contains start-up routines for the computer system 140 and a random access memory (RAM). The system bus 146 may be a memory bus, a peripheral bus or a local bus, and may be compatible with any of a variety of bus protocols, including PCI, VESA, Microchannel, ISA, and EISA. The computer system 140 also includes a persistent storage memory 148 (e.g., a hard drive, a floppy drive, a CD ROM drive, magnetic tape drives, flash memory devices, digital video disks, a server, or a data center, including a data center in a cloud) that is connected to the system bus 146 and contains one or more computer-readable media disks that provide non-volatile or persistent storage for data, data structures and computer-executable instructions

Interactions may be made with the computer system 140 (e.g., by entering commands or data) using one or more input devices 150 (e.g., but not limited to, a keyboard, a computer mouse, a microphone, joystick, a touchscreen or a touch pad). Information may be presented through a user interface that is displayed to a user on the display 151 (implemented by, e.g., a display monitor), which is controlled by a display controller 154 (implemented by, e.g., a video graphics card). The display 151 can be a display screen of a media viewing device. Example media viewing devices include touch-based devices, smart phones, slates, and tablets, and other portable document viewing devices. The computer system 140 also typically includes peripheral output devices, such as speakers and a printer. One or more remote computers may be connected to the computer system 140 through a network interface card (NIC) 156.

As shown in FIG. 1B, the system memory 144 also stores the document transformation system 10, a graphics driver 158, and processing information 160 that includes input data, processing data, and output data. In some examples, the document transformation system 10 interfaces with the graphics driver 158 to present a user interface on the display 151 for managing and controlling the operation of the document transformation system 10.

In general, the document transformation system 10 typically includes one or more discrete data processing components, each of which may be in the form of any one of various commercially available data processing chips. In some implementations, the document transformation system 10 is embedded in the hardware of the media viewing device. In some implementations, the document transformation system 10 is embedded in the hardware of any one of a wide variety of digital and analog computer devices, including desktop, workstation, and server computers, in some examples, the document transformation system 10 executes process instructions (e.g., machine-readable code, such as computer software) in the process of implementing the methods that are described herein. These process instructions, as well as the data generated in the course of their execution, are stored in one or more computer-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

The principles set forth in the herein extend equally to any alternative configuration in which document transformation system 10 has access to a set of documents 12. As such, alternative examples within the scope of the principles of the present specification include examples in which the document transformation system 10 is implemented by the same computer system (including the computing system of a media viewing device), examples in which the functionality of the document transformation system 10 is implemented by a multiple interconnected computers (e.g., a server in a data center and a user's client machine, including a portable viewing device), examples in which the document transformation system 10 communicates with portions of computer system 140 directly through a bus without intermediary network devices, and examples in which the document transformation system 10 has a stored local copies of the set of documents 12 that are to be transformed.

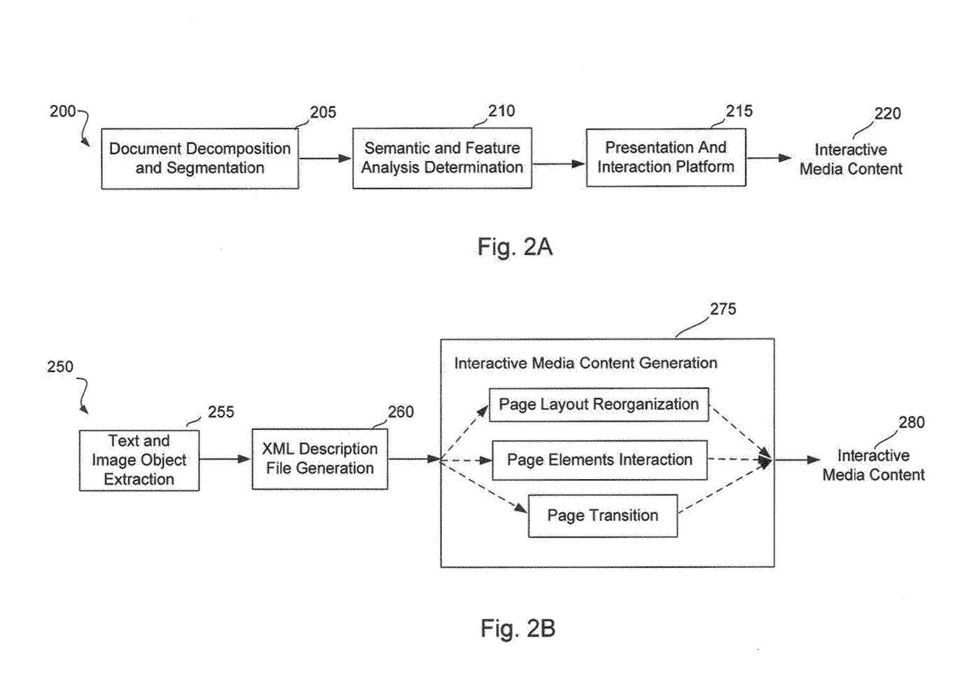

Referring now to FIG. 2A, a block diagram is shown of an illustrative functionality 200 implemented by document transformation system 10 for transforming static document into interactive media content, consistent with the principles described herein. Each module in the diagram represents one or more elements of functionality performed by the processing unit 142. The operations of each module depicted in FIG. 2A can be performed by more than one module. Arrows between the modules represent the communication and interoperability among the modules.

In an example, an engine is provided that includes machine readable instructions to generate a dynamic composition of extracted text blocks and visual blocks of a document, based on semantic features of the visual blocks and attribute data and document functions of the text blocks, to provide the interactive media content.

The decomposition and segmentation operations in block 205 of FIG. 2A are performed on a document. The decomposition and segmentation operations of block 205 serve to extract individual elements. The segmentation can be performed by segmenting (parsing) the document into functional units. Non-limiting examples of functional units include text blocks (including text identified as title, headings, and article body) and visual blocks (objects including images).

Document transformation system 10 can include an extractor that includes machine readable instructions to perform any of the functionality described herein in connection with decomposing and/or segmenting a document, including any of the functionality described in connection with block 205. The functionality of the extractor can be performed using processing unit 142. The document can be a static document. In an example, the document can be a static document in the form of a PDF. For example, the static document can be a publication in a PDF format.

In an example implementation, the extractor performs the operations in block 205 to decompose a document and segment the document into text blocks and visual blocks based on visual properties. The operations of block 205 can be performed by more than one module. In an example where the document is comprised of more than one page, the operations in block 205 can be performed on at least one page of the document. Several document analysis techniques can be applied in this block. In an example, the extractor traverses the document structure to de-layer the text and images of the document.

In an example, the operation of block 205 can be performed as described in U.S. provisional application No. 61/513,624, titled “Text Segmentation of a Document,” filed Jul. 31, 2011.

The operations of block 205 can be implemented for analysis of PDF documents, including technical documents and other documents in PDF format. The technical documents may have simple layout and may be homogenous in text fonts. In an example, other documents in PDF format, such as but not limited to consumer magazines, may have more complex layouts and include differing text fonts. The text blocks and visual bock (including image objects) can be designated as the basic unit for user interaction. These units are also the starting point for reading order determination. These structures may not be readily accessible in a document in PDF format. For example, a document in PDF format may maintain text runs and rectangular image regions. The text runs may correspond to text words. Image object segmentation is also used to provide the visual blocks. The extractor can implement PDF document segmentation to identify semantic structures from unstructured internal PDF data utilizing some visual properties. The operations of block 205 may be performed as text grouping operations and image object segmentation operations.

A non-limiting example of a text grouping operation to provide text blocks is as follows. In a document, text can be represented as words with attributes of font name, font size, color and orientation. A text grouping operation can be performed to group the words into text lines, and group text lines to text segments or text paragraphs. In an example, the operations are performed on text of horizontal orientation or vertical orientation. To group words into lines, a text line can be identified and an available word can be added to the text line. Candidate words can be identified to add to the text line on both the left end and the right end of the text line. Text blocks include text lines, text segments, and text paragraphs.

Non-limiting examples of conditions that can be imposed for determining if a candidate word is to be added to the text line include the following. The difference between the font size of the candidate words and the font size of the text line can be restricted to not exceed one point. The horizontal distance between the bounding box of the candidate word and the bounding box of the text line can be restricted to be less than the nominal character space for the font and to be the smallest among all available words. The vertical overlap between the bounding box of the candidate word and the bounding box of the text line can be restricted to be more than a predetermined threshold value. For example, the vertical overlap can be restricted to be more than about 20%, more than about 30%, more than about 40%, or more than about 50%.

If no candidate word meets the conditions, no word is added to the current text line. A new text line can be started and the conditions can be applied to grow the new text line. In an example, candidate words need not have the some font style as the words in a text line to be added to the text line. As a non-limiting example, a document may include Uniform Resource Locator (URL) links and names that have different font styles.

For each text line, metrics of font size and central location can be computed. In an example, the metrics can be weighted by lengths of words. To group text lines into segments, the text lines can be sorted in top-down fashion. As a non-limiting example, a new segment can be identified based on one or more of the identified text lines, and an available text line can be added to it. The segment can be grown by adding candidate text lines to it. In an example, the segments form the text blocks.

The text grouping operation can be implemented using a machine learning tool or a manual user verification/correction tool.

A non-limiting example of an image object segmentation operation to provide visual blocks is as follows. An image object, including a PDF image object, may include multiple semantic image objects. An accurate shape of an image region can facilitate precise user interactions and rendering. The image object segmentation can be performed based on image values of image forming elements (including pixels) of the image objects. For example, foreground pixels and background pixels can be classified. A color distance can be computed between each pixel and a pre-defined background pixel in RGB color space. In an example, the background pixel can be defined as a white pixel (255,255,255) in RGB color space. The connected component analysis can be used to identify image objects from foreground pixels.

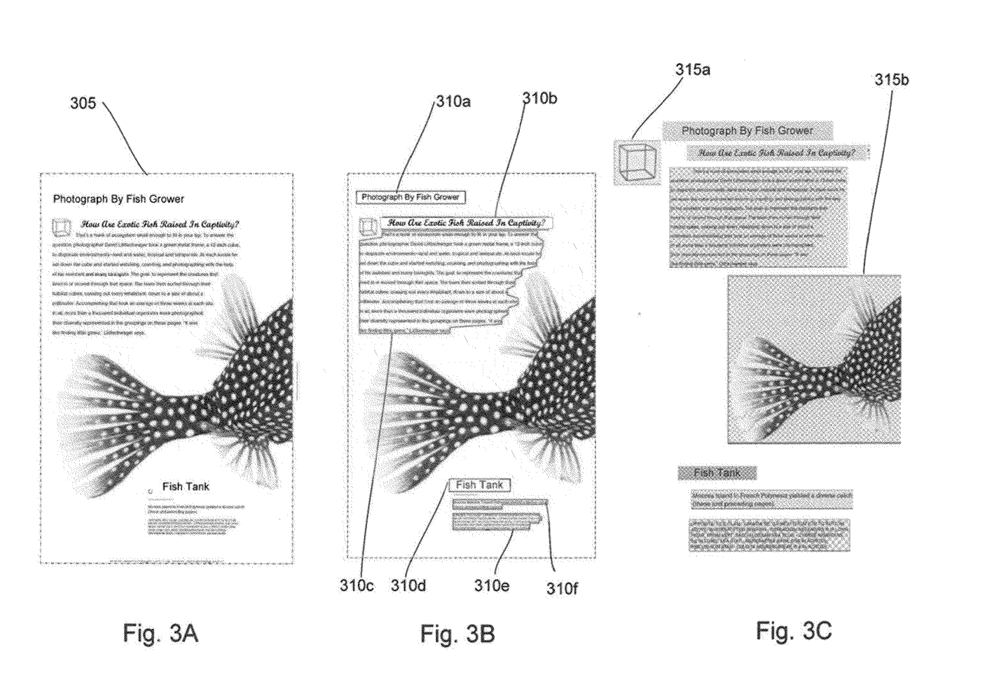

FIGS. 3A, 3B and 3C illustrate an example implementation of a text grouping operation to provide text blocks and an image object segmentation operation to provide visual blocks. FIG. 3A illustrates an example PDF document 305 to which the operations of block 205 are applied. FIG. 3B shows a result of the text grouping operation on the document. The text is ultimately grouped into six segments 310a-310f. FIG. 3C illustrates the result of the image object segmentation operation. Two image objects 315a-315b are identified. The two segmented image objects and six text blocks are shown in gray boxes. The check board pattern around the image objects shows the transparency (alpha channel) detected. As illustrated in FIG. 3C, images with arbitrary shapes can be segmented and shown separately. This adds flexibility for further page interaction and transition design. As illustrated in FIG. 3C, the text blocks can be rendered as images to keep the original appearance and for the purpose of adding flexibility, for example, for a page transition applied to provide the interactive media content.

The operations of block 205 can be performed to provide an analysis of the structure of a PDF document. The resulting individual elements of the document from the analysis can be merged and clustered into blocks and regions in a bottom-up way. For example, the text letters can be merged and clustered into paragraphs and columns. In addition to the analysis of the document structure, optical character recognition (OCR) and image analysis can also be applied. For example, page information of the document can be derived from analysis of the table-of-content page of the document, whether an image spread across pages of the document (in an example with a multi-page document) can be determined by image analysis of adjacent pages.

In block 210, semantic and feature analysis are performed based on the results of block 205. Document transformation system 10 can include an analyzer to perform any of the functionality described herein in connection with performing semantic and feature analysis, including any of the functionality described in connection with block 210. The functionality of the analyzer can be performed using processing unit 142. The operations of block 210 can be performed by more than one module. From the results of the visual structure of the document generated at block 205, semantics are inferred and features of the visual blocks of the document are computed. A variety of techniques with different complexity can be applied.

The operations of block 210 can be performed on a document in PDF format. For the text of the PDF document, operations of block 210 can extract attributes of the text blocks, including numbers, dates, names, including acronyms, and locations. Analysis algorithm can derive attributes such as, but not limited to, the topes of the document. Operations of block 210 can determine attributes such as, but not limited to, the function of the text portions of the document. For example, it can be determined whether a certain text block of the document is the title of the article based on its location and font size.

Machine learning tools and statistical approach can be used to derive templates and styles based on collections of other similar documents.

For images of the document, operations of block 210 can extract and combine those images if they are determined to belong to a single image. To index the images, a scale-invariant feature transform (SIFT) feature descriptor can be used to compute visual words from salient elliptical patches. For example, visual features can be obtained based on advanced invariant local features, such as using SIFT in computer vision to detect and describe local features in images. See, e.g., D. O. Lowe, 2004, Distinctive Image Features from Scale-Invariant Keypoints, International Journal of Computer Vision 60(2): 91-110. The images of the document can be represented as visual words that can be indexed and searched efficiently using an entry for each distinct visual word. Image elements in a document can include text, for example but not limited to, advertisement insertion in an article in a magazine. For such type of document, in addition to the SIFT feature, operations of block 210 can also index these images based on embedded text extracted by, for example, optical character recognition (OCR), to recognize logos and brands. An example of a program that can provide such functionality is SnapTell™, available from A9.com, Inc., Palo Alto, Calif. To improve robustness to OCR errors, instead of using raw strings extracted by OCR, 3-grams can be computed from the characters in these strings. For example, the word “invent” is represented as a set of 3-grams: (inv, nve, ven, ent). The module can treat each unique 3-gram as a visual word and includes it in the index structure used for visual features.

In a non-limiting example, an output from the operations of block 210 is an Extensible Markup Language (XML) file. The semantics and visual word index derived in the operation of block 210 can be stored as annotations in the same XML the as the result from the operation of block 205. In an example, the XML file can be used to describe the visual structure of the document and rendered document images in multiple resolutions. For example, an XML-based description format can be used to organize the results of decomposition and segmentation of a PDF document.

In an XML format, information blocks from each page of the document are stored as a node in a hierarchical tree structure in an XML file. Examples of information blocks include text blocks (including main body text, headings, and title) and visual blocks (including image objects). For each information block, semantic features, including its position, size, text content and reference images, are stored as attributes of its corresponding node. In a non-limiting example, multiple versions of an image are stored for each information block. They can be used for displaying the page in different modes (e.g., in portrait mode or in landscape mode) on the media viewing device. This also facilitates the display of the page on portable viewing devices of different aspect ratios. This can reduce the chances or eliminate aliasing, by facilitating display of information blocks in appropriate size for different viewing modes or for media viewing devices of different aspect ratios. It can also facilitate an increase in the speed of a system performing the operations. For example, only the matched version of an image can be loaded for different modes or for media viewing devices of different aspect ratios.

Non-limiting examples of semantic features of text blocks and visual blocks include title, heading, main body, advertisement, position in the document, size, reading order of the text blocks, links between images of the visual blocks for multi-page images), and links between articles of the document.

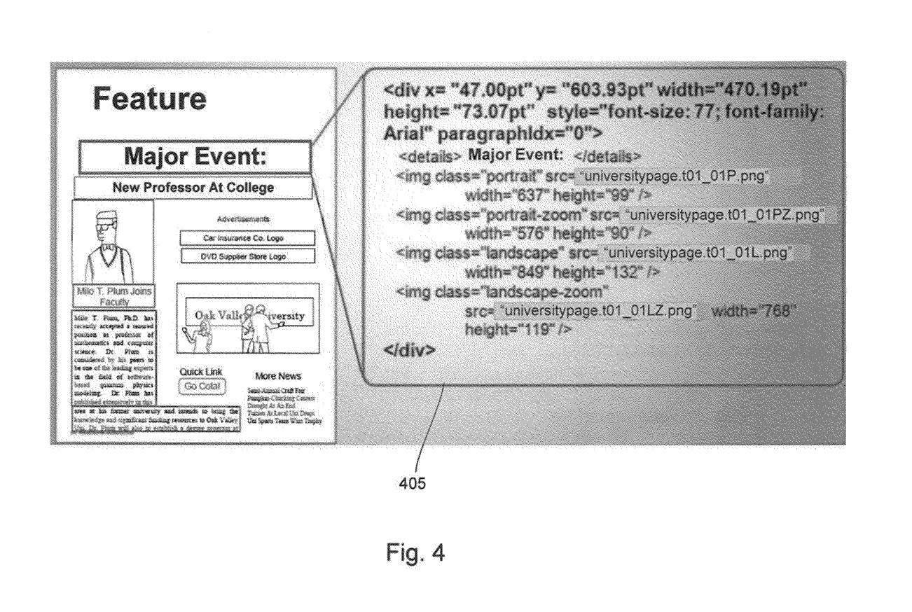

FIG. 4 illustrates an example of page of a document in which a node 405 is identified. Each identified information block in the document is marked in a frame. The XML description of the “Major Event” information block is shown in node 405, in which four different versions of the image are stored.

The operations of block 215 provide a presentation and interaction platform. Document transformation system 10 can include an engine to perform any of the functionality described herein in connection with providing a presentation and interaction platform, including any of the functionality described in connection with block 215. The implementation of block 215 provides the interactive media content. The functionality of the engine can be performed using processing unit 142. The operations of block 215 can be performed by more than one module.

To generate the dynamic composition described herein, the engine can include functionality to apply transitions or animations the text blocks and/or the visual blocks. For example, the transition and animation effects may be applied using an application program interface (API). In a nonlimiting example, the transition and animation effects may be implemented using APIs in Xcode® (software, from Apple Inc. Cupertino, Calif.). In another non-limiting example, the transition and animation effects may be implemented using an Open Graphics Library (OpenGL®) (software, from Khronos Group, Beaverton, Oreg.), including OpenGL for Embedded Systems (OpenGL ES®). In another non-limiting example, the transition and animation effects may be implemented using Quartz® (software, from Apple Inc., Cupertino, Calif.). In another non-limiting example, the transition and animation effects may be implemented using a Windows® Graphics Device Interface® (GDI) (software, from Microsoft Corporation, Redmond, Wash.), including Windows® GDI+®, or Windows Presentation Foundation® (WPF) (software, from Microsoft Corporation, Redmond, Wash.). In different platforms, the animations and transitions can be applied by combining user interface APIs. For example, a user-interface library is applicable if it can support graphics operations for user interfaces (such as, support transparency, smooth moving, fade in/fade out). Non-limiting examples of user-interlace libraries include Keynote (software, from Apple Inc., Cupertino, Calif.), UIView (software, from Apple Inc., Cupertino, Calif.), CAKeyFrameAnimation (software, from Apple Inc., Cupertino, Calif.), and cocos2d.

Following are example implementations of block 215 that can be configured for a portable viewing device, including touch-based devices, smart phones, slates, tablets, e-readers, and other portable document viewing devices.

Given the XML generated from the operations of block 210, the functionality of block 215 utilizes mechanism similar to style sheet to transform the original static document into interactive media content. For example, the interactive media content can be provided in the form of an e-publication that contains engaging visualization of the document content. The interactive media content can facilitate new user interactions beyond the original static document. For example, the functionality of block 215 can present different transitions and animations to different page elements of the output interactive media content with regard to their semantics determined in block 210. The one or more modules of block 215 provide functionalities for presenting the results from block 210 on an interactive platform, such as a viewing device. Non-limiting examples of viewing devices include a portable viewing device such as touch-based devices, including smart phones, slates, and tablets, and other portable document viewing devices. Examples of such functionalities to provide the interactive media content include an article reading mode, multi-page article browsing or figure browsing, and dynamic page transitions.

The operations of block 215 can be implemented to enhance a user's reading experiences beyond simple zooming and paging. The user experience can be enhanced in aspects based on page segmentation analysis. Interactive media content 220 can be generated using page layout reorganization, page elements interaction, or page transitions, or any combination of the three. Page layout reorganization facilitates intelligent computation and reorganization of document content for better reading. Page elements interaction allows users to interact with pieces of text and image content of the document. Page transitions can be used to add visually appealing effects to increase reader engagement.

The interactive media content 220 can be generated using page layout reorganization, page elements interaction, or page transitions, or any combination of the three, as described herein. The interactive media content 220 generated using page layout reorganization can facilitate display in an article reading mode. The interactive media content 220 generated using page elements interaction can facilitate display of image zooming, multi-page article browsing, multi-page image browsing, or multi-column scrolling. The interactive media content 220 generated using page transition can facilitate display using transition effects based on page elements properties.

An example of operation of block 215 to provide page layout reorganization is described. Readability of a document on a portable viewing device can be increased by reorganizing the layout of page contents. A non-limiting example of such a document is a magazine article having a multi-column style. The font size in the columns may be too small to read easily even on handheld devices with middle-size displays in portrait view. A non-limiting example is a PDF reader that allows a user to zoom in to look at the small font, but this may not be a good solution from the readers' perspective. A portable document viewing device such as e-readers may provide specially designed format with proper font size for e-publications suitable for reading on these devices, however, this may require a format redesign of the content.

The operations of block 215 provide an article reading mode for page layout reorganization. In this article reading mode, the operations of block 215 can use the results of blocks 205 and 210 to put all text content of a document together to form a clear single reading scroll. To form a single reading column in the correct order, a rule-table-based heuristic algorithm can be used to compute the reading order for each text block in a document. A non-limiting example of rule sets is shown in Table 1.

TABLE 1
Example rule table for computing reading order.

| Rule Set | Rank |
|---|---|
| Font size and style | 1 |
| TextBlock.origin.x | 2 |
| TextBlock.origin.y | 3 |
| TexBlock Column Width | 4 |

Given a set of text blocks of a document, a two pass technique (and associated algorithm) to compute the reading order for each text block. In the first pass, based on a rule table, titles and footnotes with the main body text can be distinguished. Buckets can be created based on the width of the information blocks to identify a group of blocks that have smallest variation in width. Combining these two steps, main body text can be distinguished from other types of information blocks. In the second pass, the reading index of each main body text block can be computed based on its position in the original page layout.

In an example, the transition between the original page layout and the article reading mode can be animated. For example, in response to a user-made gesture or other user indication, including a keystroke indication, a touch, a cursor positioning, a stylus tap, or a finger tap, the display of the document on the media viewing device can be animated to reorganize from the original display to display in the article reading mode. In an example, the system can be configured so that a user-made gesture or other user indication at a region of the display or of the document initiated the reorganization to the article reading mode. For example, animation can be applied to cause the text blocks of the document to pop up and visually reorganize to form a long article reading scroll in the article reading mode. In another example, animation can be applied to cause the display to zoom in and scroll to the exact location in the article indicated by the user-made gesture or other user indication.

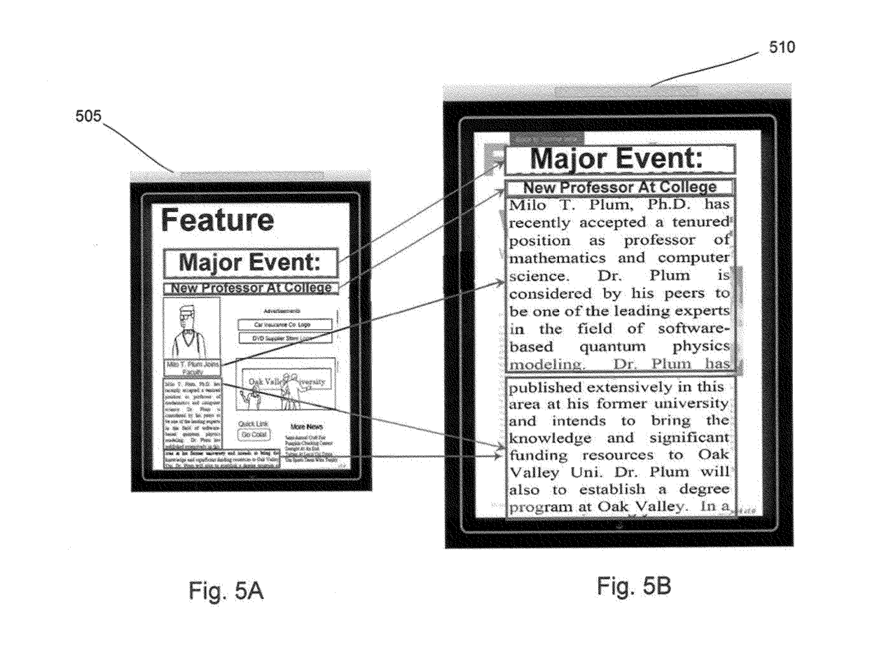

An example implementation of block 215 for page layout reorganization to an article reading mode is illustrated in FIGS. 5A and 5B. The example article reading mode display of page 505 is a display 510 in portrait view. A smooth animation is applied from change in display between the two modes. This implementation facilitates enhancement of the original document 505 for easier reading. A functionality of block 215 uses the results of the operations of blocks 205 and 210 to determine the portions of the document 505, including title, heading, and main body. These portions of the document are displayed in a larger font having higher resolution to a viewer, as illustrated in FIG. 5B. In FIG. 5B, the article reading mode display occupies about 75% of the width of the screen (about 576 pixels) in the portrait mode of a media viewing device (in this example, a tablet). In this example, the original page is rendered semi-transparently as the background. The system can be configured so that a user-made gesture or other user indication (such as a tap) can cause the background to switch back to the ordinary page view. These parameters can be chosen to provide settings for making reading of multi-column articles easier on media viewing devices, including on smaller tablet devices and on other devices with middle-size displays.

Another example implementation of block 215 for page layout reorganization facilitates removing unrelated content, including advertisement, or adding additional content, to provide the interactive media content. This implementation may applicable for a document that includes a large number and area of unrelated content, including advertisements. In an example, this implementation may be applicable to professionally designed magazines.

An example of operation of block 215 to provide page elements interaction is described. Page elements interaction can be used to make pieces of the magazine page interactive. Example implementations of page elements interaction include multi-column scrolling, multi-page article or image browsing, and single figure zooming.

A multi-column document can be made more readable on a media viewing device if it is displayed in landscape mode. Block 215 can be used to implement a multi-column scrolling mechanism to enhance reading experiences. In this implementation, a user does not need to scroll the entire page of the document to continue reading from the bottom of a previous document to the top of the next column. This implementation maintains continuity of reading. In this example, each column of the document is rendered independently in landscape mode. Therefore, each column of the document is independently scrollable to provide continuous reading experiences for the users.

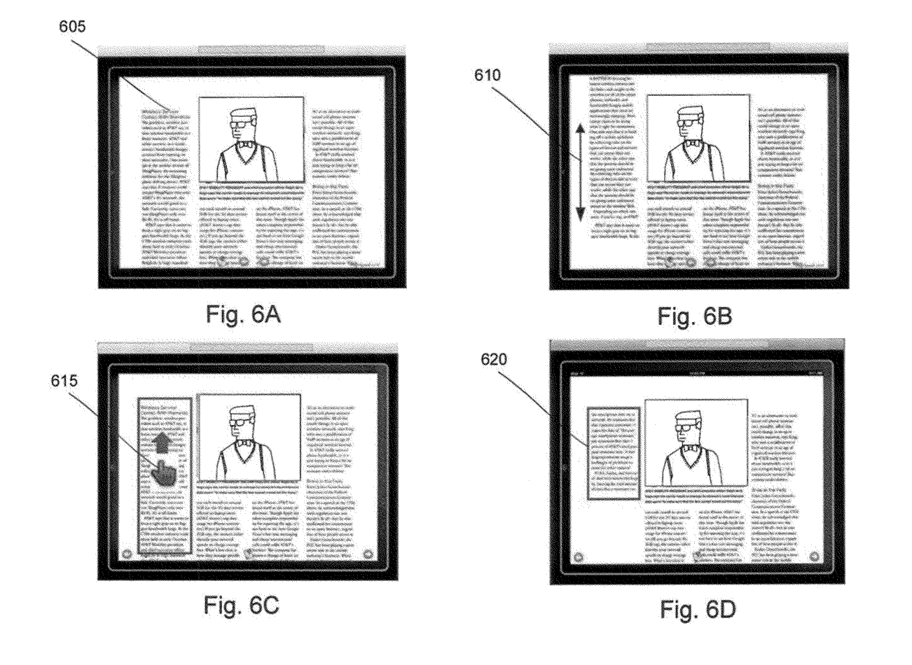

FIGS. 6A-6D illustrate an example implementation of a multi-column scrolling mechanism. FIG. 6A shows the original display of the page of the document. FIG. 6B illustrates the functionality where the first column 605 of the document page is scrolled independent of the other columns. FIG. 6B illustrates the scrolling 610 of the first column while the remainder of the document (the second, third and fourth columns) remain substantially static. FIG. 6C illustrates another type of cursor or indicator 615 that can be used to indicate the scrolling of the first column. FIG. 6D illustrates a display in which the first column is scrolled upwards so that end at the first column is near the top of the second column, in this example implementation of block 215, in addition to creating animation, natural user interactions are facilitated. Also, columns of the text blocks can be scrolled independent of each other in the portrait mode so that back and forth scrolling of the entire document page to read the text columns can be avoided.

In another example, block 215 can be used to implement multi-page article or image browsing that allows a user to get a quick overview of an article or image that spans multiple pages. For example, in response to a user-made gesture or other user indication, the display of the document on the media viewing device can be animated to so that the current page zooms out and its adjacent article or image pages slide in to form an overview of the entire article or image. For example, this animation can be initiated when the user taps the margin area of a page that belongs to a multi-page article or image spread of the document. This implementation allows a user to quickly jump to any page of the document, for example but not limited to, by tapping a thumbnail in this mode.

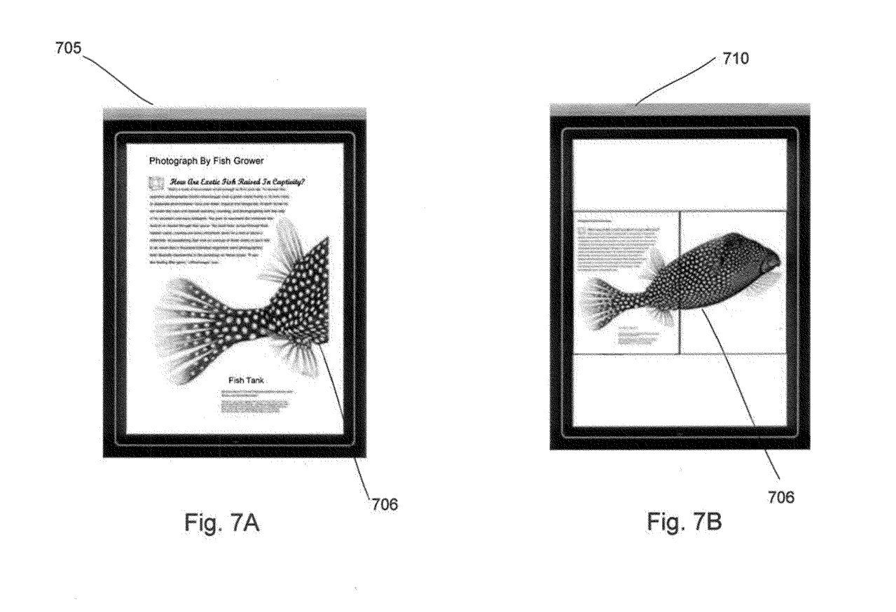

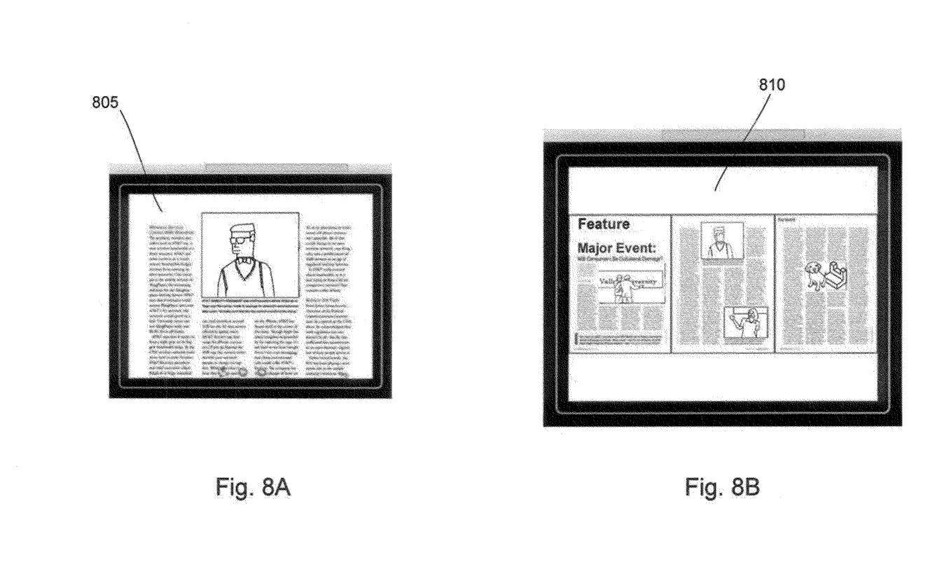

FIGS. 7A, 7B, 8A and 8B illustrate an example implementation of a multi-page article browsing mode and a multi-page image browsing mode in portrait and landscape views of a media viewing device. In FIGS. 7A and 7B, the original document 705 includes an image 706 that spans more than one document page. This implementation provides a multi-page view 710 that shows the entire image 706 in a portrait page orientation. A functionality of block 215 uses the results of the operations of blocks 205 and 210 to determine the portions of image 706 that span the document pages, and brings the sections of the image 706 together and displays them in the portrait page orientation (FIG. 7B). In FIGS. 8A and 8B, the original document 805 is displayed in a multi-page view that spans more than one document page of document 805, in a landscape orientation. A functionality of block 215 uses the results of the operations of blocks 205 and 210 to display in a multi-page view the different document pages of document 805 in a landscape orientation (FIG. 8B).

In another example block 215 can be used to implement single figure zooming. For example, the implementation facilitates zooming to a image in response to a user-gesture or other user indication to fit the image to the dimensions of the display. The remainder of the document can be faded to provide a background. An example user-gesture is if a user taps the image in the document.

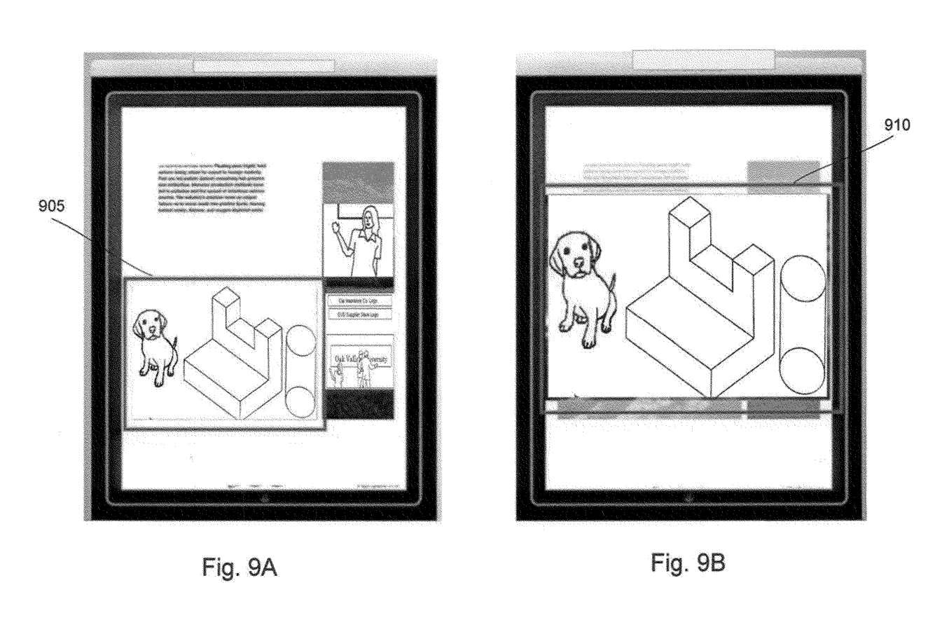

FIGS. 9A and 9B illustrate an example implementation of the single figure zooming. In response to a user-gesture or other user indication relative to image 905 of the document (See FIG. 9A), the image is presented in a view in full screen 910 (See FIG. 9B).

Another example implementation of block 215 for page elements interaction facilitates indexing names and keywords associated with the pages of a document for searches, to provide the interactive media content using the extracted semantic meaning of page entities. In this implementation, a user may, for example, tap (or otherwise select) a photographer's name on the display to retrieve all the photos taken by this photographer across the entire magazine collection.

An example of operation of block 215 to provide page transitions is described. Page transitions can be used to add visually appealing effects to increase reader engagement. Block 215 can be implemented to apply transition effects to different elements of the document to increase visual appeal of the display. Page transitions can be used to better present the content structure of documents to users by distinguishing text from images, and headings and titles from body text and callouts in animations and transitions. When user switches document pages, block 215 is configured to apply different, respective transition effect to each information block (including main body text, image object, headings, and title). Examples of transition effects that can be applied include fade in/fade out of document page, slide in/slide out of document page, and cross-dissolve of document pages. In another example, page transitions can be applied for advertisement insertion, such as highlighting. In an example, the page transitions can be applied to update or change advertisement insertions during user interaction.

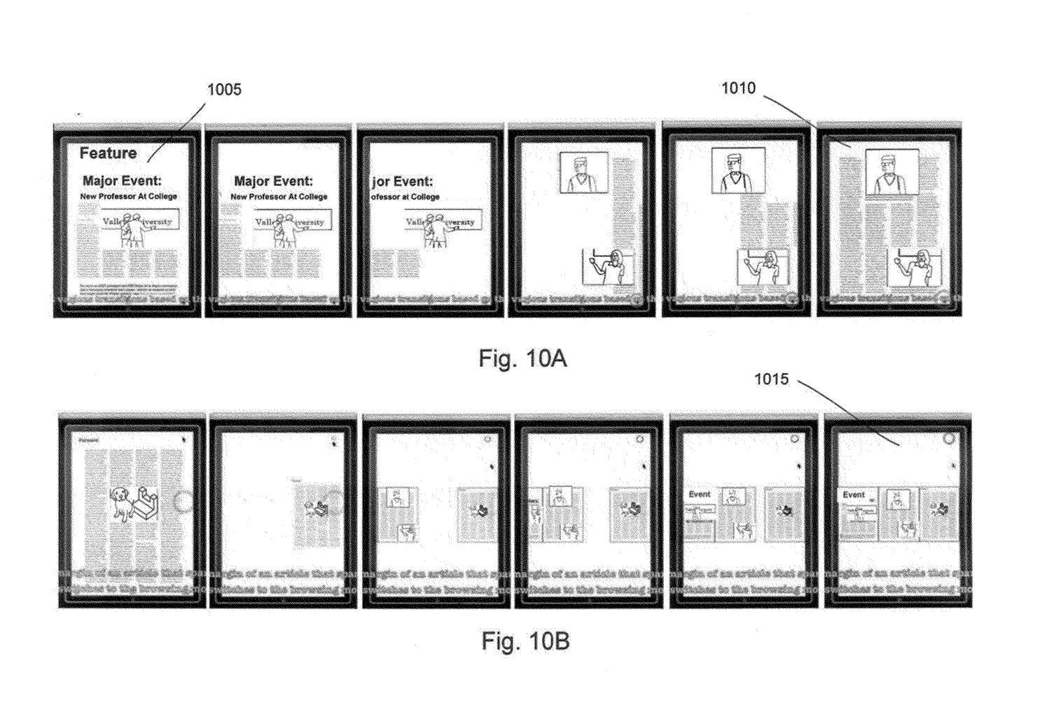

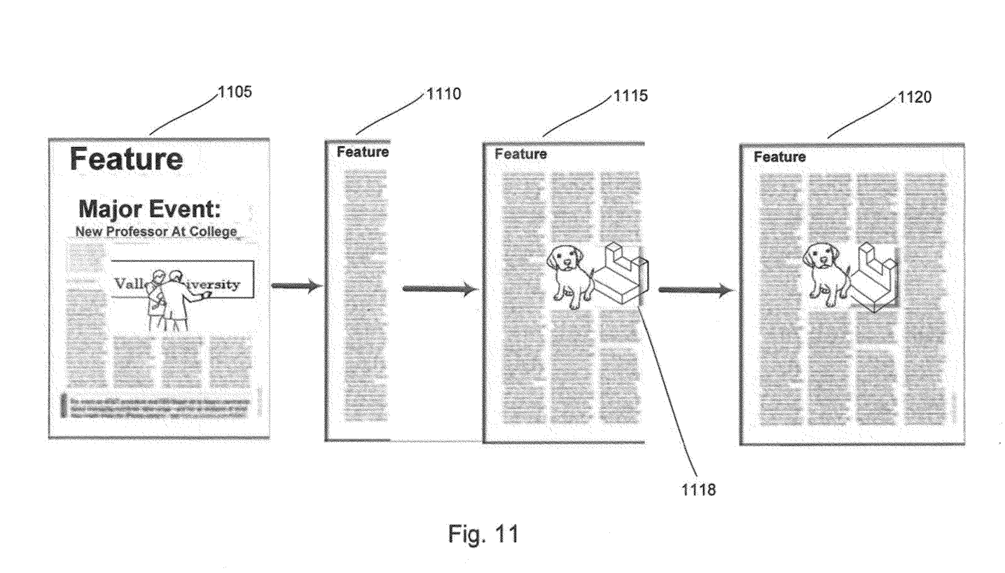

Example transition effects are illustrated in FIGS. 10A and 10B. In FIG. 10A, the content of a first page 1005 is caused to fade out and move to the left of the screen while the second page 1010 is caused to fade in. In this example, different transition effects are applied to the image objects and text content. In FIG. 10B, in response to a user gesture or other user indication, an overview of the multipage document 1015 is shown. In this example, the system can allow the user to easily jump to any page of the document in response to a user gesture or other user indication in this overview mode. For example, a user can jump to a page of the document by tapping on the page in the overview mode of the display.

In another example implementation of block 215, the folding of text columns can be animated, similarly to a brochure. FIG. 11 illustrates this implementation of block 215. In transitioning from a first page 1105 of a document to the second page, the columns of the second page are displayed in stages. In the example of FIG. 11, the first column is displayed first 1110, then the combined second and third column are displayed 1115. In this example, the second and third columns are displayed as a unit 1115 since an image 1118 links the columns. The fourth column is then displayed to provide the entire second page 1120.

Another example implementation of block 215 for page elements interaction facilitates applying different transition templates or styles for different types of content, to provide the interactive media content. In this implementation, static print advertisement can be automatically converted into animated display advertisements.

In other example implementations of block 215, different entrance animations can be applied to different elements of the document. A functionality of block 215 uses the results of the operations of blocks 205 and 210 to determine the functions of different portions of the static document, including title, heading, main body, and advertisement. In an example where the document is a multipage document, between-page transitions can be configured to be more “live” than a simple page turning by distinguishing article title from the other portions of the document. The different entrance animations can be applied, for example, to have the page load in stages. For example, for the first page of the document, the article banner and document title may appear first, then the document header, main body and image(s) can be displayed, and then any advertisement can be displayed gradually. For the second page, a header, the main body and image(s) can be displayed before any other advertisement is displayed. That is, block 215 can implement animations that facilitate a smooth document transition from one page to the other. In this manner, the document transition can be made to appear more dynamic. When a user advances from one page to a second page of the multi-page document on a portable viewing device, block 215 can be create a smooth transition, where advertisements can be updated and assembled as a viewer views the display of the viewing device. For a touch-based device, the user can make the pertinent gesture, such as sweeping a finger at the display, to cause a scrolling motion from a first page to a second page.

In another example implementation of block 215, since the system decomposes the document elements based on semantics, block 215 facilitates a user's ability to clip article content easily. For example, certain paragraphs of text can be highlighted to write comments and automatically saved to personal notepad. With the knowledge of page numbers of portions of the document from the table of content page, the functionality of block 215 can also assign vertical swipe gesture to page turn within an article and horizontal swipe gesture to skim through the pages of different portions of the document. In this example, the document can be a magazine comprised of several articles, and each portion of the document is a different article. Users can also choose to highlight or hide all the figures, numbers and images. Document collections can be indexed and browsed, for example, by topics, both visually and in text.

Another example implementation of block 215 can facilitate linking of PDF documents. Interactivity can be introduced so that a user can select a document header, and other documents having the same document header are displayed to the user. For example, other documents having the header “Feature,” as depicted in FIGS. 5B and 6A are displayed to the user. In an example, a user can tap on a column title or column header to locate the same column articles in a series of periodicals, e.g., in an archive of magazine articles.

In another example implementation, block 215 can automatically link image in the documents to external media files, including videos and photo collections, via image feature matching. As a non-limiting example, the document can be a sport magazine that is linked to small video clips of goals from football matches. As another non-limiting example, the document can be a cooking magazine that is linked to video clips that demonstrate cooking preparation techniques.

In another example implementation, block 215 can automatically replace old static advertisement image with updated animated advertisement or video clips provided by the advertiser.

Referring now to FIG. 2B, a block diagram is shown of another illustrative functionality 250 implemented by document transformation system 10 for transforming static document into interactive media content, consistent with the principles described herein. Each module in the diagram represents one or more elements of functionality performed by the processing unit 142. The operations of each module depicted in FIG. 2B can be performed by more than one module. Arrows between the modules represent the communication and interoperability among the modules.

The text and image object extraction operations in block 255 of FIG. 2B are performed on a document as described herein in connection with blocks 205 and 210 of FIG. 2A. For example, a segmentation algorithm can be applied to analyze the content of each page of the document to extract its text and image. Each text segment and image object, i.e., information block, can be labeled for its semantics, such as a document title and author name, and stored separately. The reading order of the text content of the document can be computed, multi-page images and articles can be linked, and an XML description file generated. The XML description file generation operations in block 260 can be performed as described herein in connection with block 210 of FIG. 2A. The XML description file can be used to store the reading order computation, the title and main text body detection result, and the multi-page article or image labels.

In block 275, interactive media content is generated as described herein in connection with block 215 of FIG. 2A. The operation of block 275 can parse the XML file and map the semantics of the mark-up in runtime into interactive behaviors in an application that runs on the media viewing device. For example, the application can be an app that runs on a tablet, slate, smartphone, e-reader, or other portable document viewing device. The interactive media content 280 can be generated using page layout reorganization, page elements interaction, or page transitions, or any combination of the three, as described above. The interactive media content 280 generated using page layout reorganization can facilitate display in an article reading mode. The interactive media content 280 generated using page elements interaction can facilitate display of image zooming, multi-page article browsing, multi-page image browsing, or multi-column scrolling. The interactive media content 280 generated using page transition can facilitate display using transition effects based on page elements properties. The document can be a static document. In an example, the document can be a static document in the form of a PDF. For example, the static document can be a publication in a PDF format.

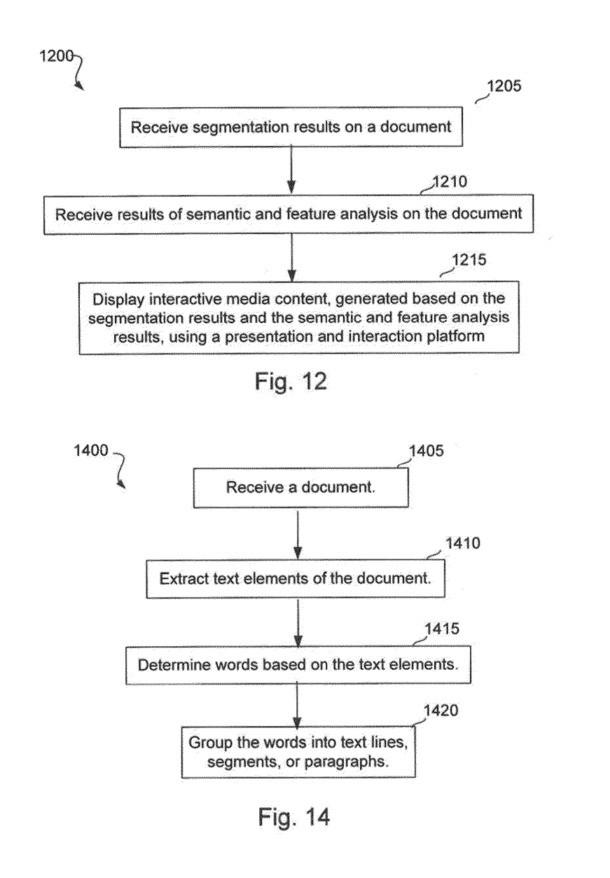

Referring to FIG. 12, a flowchart is shown of a method 1200 summarizing an example procedure for transforming a document into interactive media content. In an example, the document is a static document. The method 1200 may be performed by, for example, the processing unit (142, FIG. 1) coupled with document transformation system (10, FIG. 1). The method 1200 includes performing segmentation 1205 on a document, performing semantic and feature analysis 1210 on the document, and displaying 1215 interactive media content, generated based on the segmentation results of block 1205 and the semantic and feature analysis results of block 1210, using a presentation and interaction platform. The document can be a PDF document. For example, document can be a PDF of an article, such as but not limited to a news article or a magazine article.

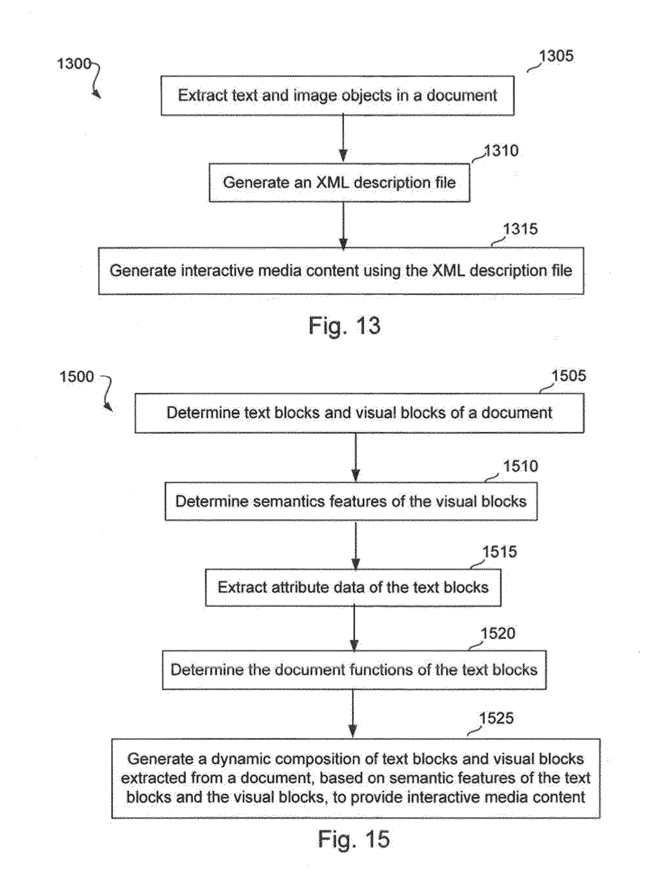

Referring to FIG. 13, a flowchart is shown of a method 1300 summarizing an example procedure for transforming a document into interactive media content. In an example, the document is a static document. The method 1300 may be performed by, for example, the processing unit (142, FIG. 1) coupled with document transformation system (10, FIG. 1). The method 1300 includes extracting text and image objects 1305 in a document, generating an XML description file 1310 using the results from block 1305, and generating interactive media content 1315 using the MIL description file 1310. The document can be a PDF document. For example, document can be a PDF of an article, such as but not limited to a news article or a magazine article.

Referring now to FIG. 14, a flowchart is shown of a method 1400 summarizing an example procedure for extracting text content from a document. In an example, the document is a static document. The method 1400 may be performed by, for example, the processing unit (142, FIG. 1) coupled with document transformation system (10. FIG. 1). The method 1400 includes receiving the static document 1405, extracting text elements of the document 1410, determining words based on the text elements 1415, grouping the words into text lines 1420. The text lines may be grouped into text segments or paragraphs 1410. The text blocks may be the text lines, text segments, or text paragraphs.

Referring now to FIG. 15, a flowchart is shown summarizing an example procedure 1500 for transforming a document into interactive media content. In an example, the document is a static document. The method 1500 may be performed by, for example, the processing unit (142, FIG. 1) coupled with document transformation system (10, FIG. 1). The method 1500 includes determining text blocks and visual blocks of a static document 1505, determining semantic's features of the visual blocks 1510, extracting attribute data of the text blocks 1515, and determining the document functions of the text blocks 1520. The method 1500 also includes generating a dynamic composition of the text blocks and visual blocks 1525, based on the semantic features of the visual blocks and the attribute data and document functions of the text blocks, to provide interactive media content.

The preceding description has been presented only to illustrate and describe embodiments and examples of the principles described. This description is not intended to be exhaustive or to limit these principles to any precise form disclosed. Many modifications and variations are possible in light of the above teaching.

Many modifications and variations of this invention can be made without departing from its spirit and scope, as will be apparent to those skilled in the art. The specific examples described herein are offered by way of example only, and the invention is to be limited only by the terms of the appended claims, along with the full scope of equivalents to which such claims are entitled.

As an illustration of the wide scope of the systems and methods described herein, the systems and methods described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

All references cited herein are incorporated herein by reference in their entirety and for all purposes to the same extent as if each individual publication or patent or patent application was specifically and individually indicated to be incorporated by reference in its entirety herein for all purposes. Discussion or citation of a reference herein will not be construed as an admission that such reference is prior art to the present invention.

What is claimed is:

1. A system to transform a document into interactive media content comprising:
memory for storing computer executable instructions; and
a processing unit for accessing the memory and executing the computer executable instructions, the computer executable instructions comprising:
an engine to generate a dynamic composition of text blocks and visual blocks extracted from a document, based on semantic features of the text blocks and the visual blocks, to provide interactive media content.

2. The system of claim 1, wherein the computer executable instructions further comprise an extractor to:
receive the document, extract text elements of the document;
determine words based on the text elements; and
group the words into text lines, text segments, or text paragraphs, wherein the text blocks comprise the text lines, text segments, or text paragraphs.

3. The system of claim 1, wherein the semantic features of the text blocks and visual blocks are at least one of a title, a heading, a main body, an advertisement, a position in the document, a size, a reading order of the text blocks, a link between images of the visual blocks, and a link between articles of the document.

4. The system of claim 1, wherein the engine further comprises computer executable instructions to:
receive an extensible markup language (XML) file comprising information indicative of the semantics features; and
generate the interactive media content based on the XML file.

5. The system of claim 4, wherein the XML file comprises information indicative of the semantics features stored as nodes in a hierarchical tree structure; and wherein, to generate the interactive media content, the engine further composes computer executable instructions to:
parse the XML file; and
map the semantic features of the XML file in runtime into interactive behaviors, thereby providing the interactive media content.

6. The system of claim 1, further comprising a display to display the interactive media content, wherein, to generate the dynamic composition, the engine further comprises computer executable instructions to apply a transition or an animation to at least one text block or at least one visual block.

7. The system of claim 6, wherein the engine further comprises computer executable instructions to apply an animation to the at least one text block or to the at least one visual block, wherein the animation causes the at least one text block or the at least one image block of the interactive media content to load in stages to the display.

8. The system of claim 6, wherein the engine further comprises computer executable instructions to apply an animation to the at least one text block, wherein the animation causes the at least one text block of the interactive media content to scroll across the display independently of other text blocks.

9. The system of claim 6, wherein the engine further comprises computer executable instructions to apply a transition to the at least one text block or to the at least one visual block; and to compose the interactive media content for display in a multi-page view, wherein the transition causes a smooth document transition from a first page of the interactive media content to a second page thereof on the display.

10. The system of claim 6, wherein the engine further comprises computer executable instructions to apply a transition to the at least one text block or to the at least one visual block; and to compose the interactive media content for display in a multi-page view, and wherein the transition causes the interactive media content to displayed on the display in a multi-page view that spans more than one page in a landscape orientation.

11. A method performed by a computer system comprising at least one processor, said method comprising:
receiving, using at least one processor, text blocks and visual blocks of a document;
receiving, using at least one processor, semantic features of the text blocks and the visual blocks; and
generating, using at least one processor, a dynamic composition of text blocks and visual blocks extracted from a document, based on the semantic features of the text blocks and the visual blocks, to provide interactive media content.

12. The method of claim 10, wherein generating a dynamic composition of the text blocks and visual blocks comprises applying a transition or an animation to at least one text block or at least one visual block.

13. The method of claim 11, wherein generating the dynamic composition comprises:
receiving an extensible markup language (XML) file comprising information indicative of the semantics features; and
generating the interactive media content based on the XML file.

14. The method of claim 13, wherein the XML file comprises information indicative of the semantics features stored as nodes in a hierarchical tree structure; and wherein generating the interactive media content comprises:
parsing the XML file; and
mapping the semantic features of the XML file in runtime into interactive behaviors, thereby providing the interactive media content.

15. A non-transitory computer-readable medium having code representing computer-executable instructions encoded thereon, the computer executable instructions comprising instructions executable to cause one or more processors of a computer system to:
receive an extensible markup language (XML) file comprising information indicative of the semantics features of the text blocks and the visual blocks of a document; and
generate a dynamic composition of the text blocks and visual blocks based on the XML file to provide interactive media content.
